(19) United States
(12) Patent Application Publication
(10) Pub. No.: US 2005/0127627 A1
(43) Pub. Date: Jun. 16, 2005

(54) Multi deck cart easy to assemble by users

(76) Inventor: Jin-Chu Lu, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/731,015

(22) Filed: Dec. 10, 2003

(51) Int. Cl. B62B 3/00

(52) U.S. Cl. 280/47.35

(57) ABSTRACT

A cart includes a bottom holding unit, two lateral plates detachably joined to lateral edges of the bottom unit at lower ends, several spaced upper holding units detachably joined to the lateral plates at two lateral ends, a handle detachably joined to one of the lateral plates, and wheels detachably joined to a lower side of the bottom unit; each holding unit has a horizontal plate, and two wall portions, which are detachably fitted to front and rear edges of the horizontal plate, and which are detachably connected to the lateral plates at two ends; the cart is in dismantled position with the above various plates being stacked up so as to occupy less space before the user assembles it.

### BACKGROUND OF THE INVENTION

1. Field of the Invention

The present invention relates to a multi deck cart, more particularly one, which can be easily assembled by regular users.

2. Brief Description of the Prior Art

There are multi deck carts available for moving objects with, which carts can be made of metal, wood or plastics. Because wood is more expensive, difficult to change to intended shape, and heavier, wooden multi deck carts are usually used as furnishings in a room. Because plastics is light in weight, plastic carts are suitable for use at home and non-manufacturing workplaces, which plastic carts usually have several decks, four wheels on the bottom, and four vertical connecting rods, which are connected with engaging concavities of the desks at engaging convexities thereof. However, plastic carts are less stable, and prone to get deformed at the supporting rods and the decks when they are loaded with heavy weights. Because metal is relatively strong, metallic carts are suitable for use in factories, which metallic carts usually have several decks, four wheels on the bottom, and vertical supporting rods, which are each connected with two adjacent desks at tow ends by means of threaded fixing elements. Metallic carts are more stable, and can be used for supporting objects with heavy weight. However, it takes much labor and time to form upright walls at the edges of a metallic plate, which is to be used as a deck. And, it also takes much time and labor to widen and flatten two ends of metallic supporting rods by means of punching machines, which supporting rods are each securely connected with two adjacent decks at the ends by means of screws or bolts. In addition, spaces will be formed on four sides of the metallic carts and the plastic carts, which spaces are between the lower side of each deck and the upright walls of a lower adjacent deck. Consequently, when the decks are loaded with too many objects, some objects are prone to fall out of the carts to cause trouble. And, even if the metallic carts and the plastic carts are available in user-assembled form, the decks thereof, which are formed with upright walls at four edges, will still, because of the upright walls, occupy much space when they are stacked up, costing more storage and transportation expense, and causing inconvenience to the consumers when they are taking them home.

### SUMMARY OF THE INVENTION

It is a main object of the present invention to provide a user-assembled multi deck cart to overcome the above disadvantages.

The cart of the present invention includes a bottom holding unit, two lateral plates detachably joined to lateral edges of the bottom unit at lower ends, several spaced upper holding units detachably joined to the lateral plates at two lateral ends, a handle detachably joined to one of the lateral plates, and wheels detachably joined to a lower side of the bottom unit. Each of the holding units has a horizontal plate, and two wall portions, which are detachably fitted to front and rear edges of the horizontal plate, and which are detachably connected to the lateral plates at two ends. The holding units are connected with the lateral plates by means of screws while the horizontal plates have protrusions at the edges, which are inserted in corresponding hooking portions formed on the edges of the wall portions; thus, the cart is easy to assemble. The cart is in dismantled position with the above various plates being stacked up so as to occupy less space before the user assembles it.

In addition, guide rails are secured to the lateral edges of the upper holding units, and drawers are supported on the guide rails.

### BRIEF DESCRIPTION OF THE DRAWINGS

The present invention will be better understood by referring to the accompanying drawings, wherein:

FIG. 1 is an exploded perspective view of the user-assembled multi deck cart according to the present invention,

FIG. 2 is a partial exploded perspective view of the user-assembled multi deck cart according to the present invention,

FIG. 3 is another partial exploded perspective view of the user-assembled multi deck cart of the present invention,

FIG. 4 is a vertical section of the user-assembled cart of the present invention, taken along a plane parallel to the front side of the cart,

FIG. 5 is a vertical section of the cart of the present invention, taken along a plane perpendicular to the front side of the cart,

FIG. 6 is a partial vertical section of the user-assembled multi deck cart of the present invention,

FIG. 7 is another partial vertical section of the user-assembled multi deck cart of the present invention,

FIG. 8 is a partial vertical section of the cart of the second embodiment, taken along a plane parallel to the front side, and

FIG. 9 is a partial vertical section of the cart of the second embodiment, taken along a plane perpendicular to the front side.

### DETAILED DESCRIPTION OF THE PREFERRED EMBODIMENTS

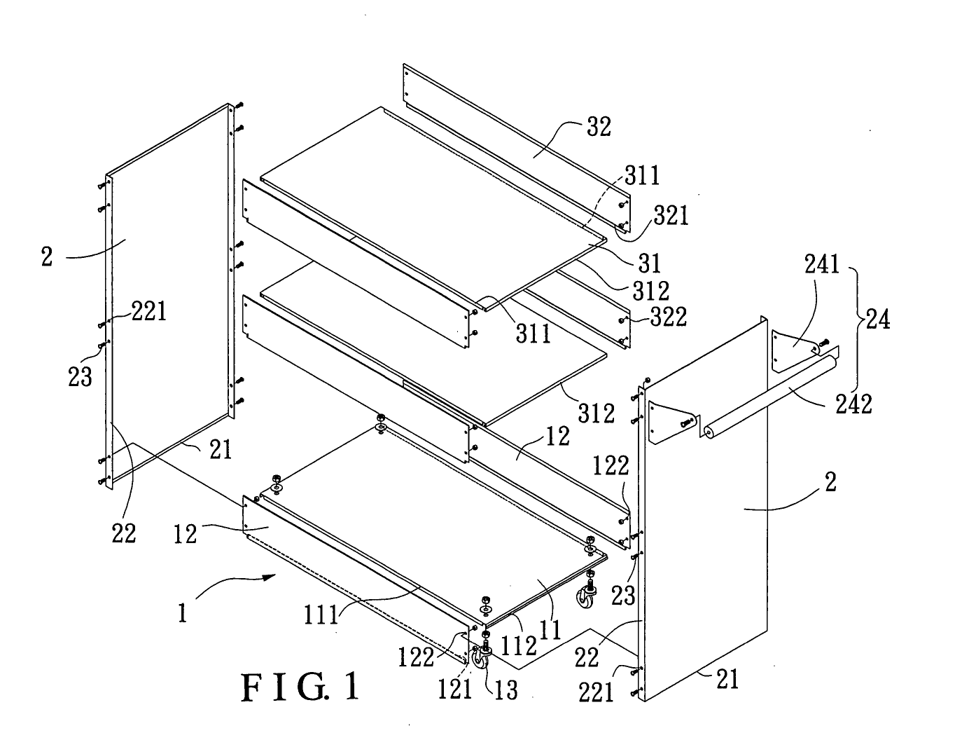

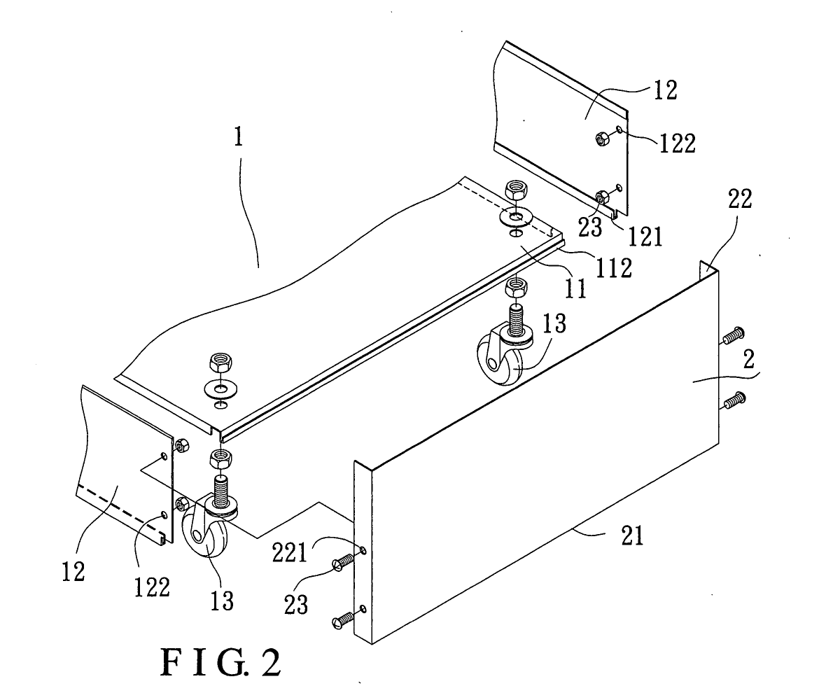

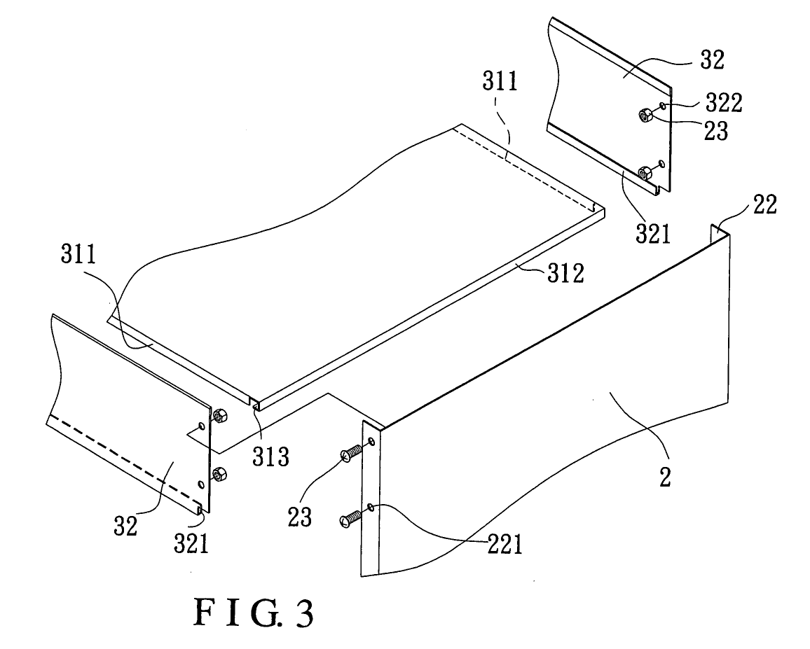

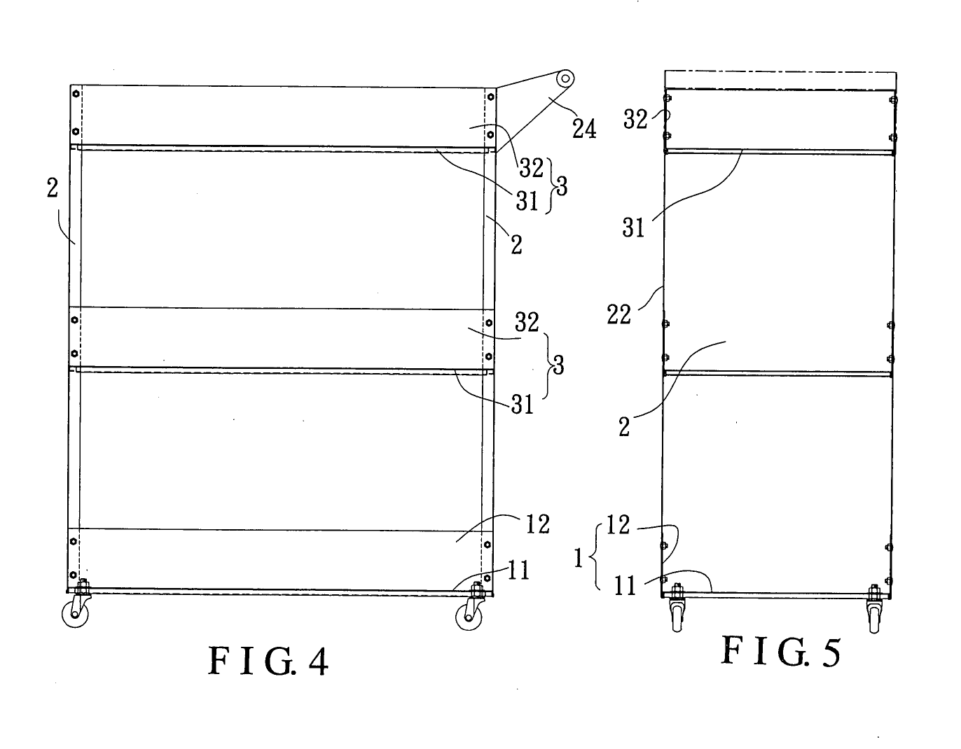

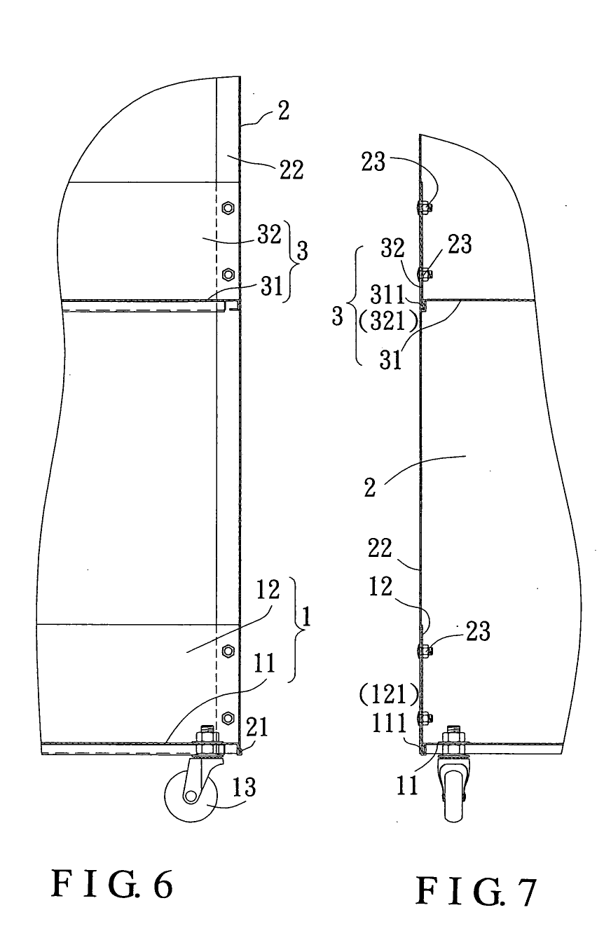

Referring to FIGS. 1 to 7, a preferred embodiment of a user-assembled multi deck cart in the present invention, which can be made of metallic or other hard materials, includes:
a bottom holding unit 1, which is comprised of a horizontal plate 11, and front and rear wall portions 12 made of narrow plates; the horizontal plate 11 is folded such that front and rear edges thereof have downwards-projecting insertion portions 111, and such that two lateral edges thereof have concave portions 112 facing upwards; each concave portion 112 has a trench defined by two vertical sections, a lower horizontal section perpendicular to the vertical sections; each wall portion 12 has through holes 122 on two ends, and is folded at a lower edge so as to have a hooking portion 121, which has a trench defined by two vertical sections, a lower horizontal section perpendicular to the vertical sections; the horizontal plate 11 is inserted in the hooking portions 121 of the wall portions 12 at the insertion portions 111 thereof;
two lateral plates 2 arranged next to the lateral edges of the bottom holding unit 1 in upright position; each lateral plate 2 has a lower end 21, and is folded such that front and rear edges thereof have connecting portions 22 projecting from, and perpendicular to a flat portion thereof; the connecting portions 22 have through holes 221 spaced along them; the lateral plates 2 are respectively inserted in the concave portions 112 of the bottom holding unit 1 at the lower ends 21, and are securely connected with the wall portions 12 at the connecting portions 22 thereof by means of nuts (not numbered), and threaded fixing elements 23, which are passed through the through holes 122 and 221;
several upper holding units 3 spaced apart between the lateral plates 2; each holding unit 3 is comprised of a horizontal plate 31, and front and rear wall portions 32 made of narrow plates; each horizontal plate 32 is folded such that front and rear edges thereof have downwards-projecting insertion portions 311, and such that each lateral edge thereof has a vertical section 312, and a horizontal section 313 projecting inwards from the vertical section 312; each wall portion 32 has through holes 322 on two ends, and is folded at a lower edge so as to have a hooking portion 321, which has an upward trench defined by two vertical sections, a lower horizontal section perpendicular to the vertical sections; the lateral plates 2 are securely connected with the wall portions 32 at the connecting portions 22 thereof by means of nuts, and threaded fixing elements 23, which are passed through the through holes 221 and 322, and are pressed against the vertical sections 312 of the lateral edges of the horizontal plates 31;
wheels 13 fitted to the lower side of the horizontal plate 11; and
a handle 24 opposing an outer side of a first one of the lateral plates 2, and secured to the first lateral plate 2; the handle 24 includes two supports 241, and a main body 242 securely connected with the supports 241 at two ends; the supports 241 are connected to the connecting portions 22 of the corresponding lateral board 2 by means of threaded fixing elements.

Thus, openings are provided on the front and the rear sides of the present multi deck cart, and objects can be put into the holding units 1, and 3 via the spaces.

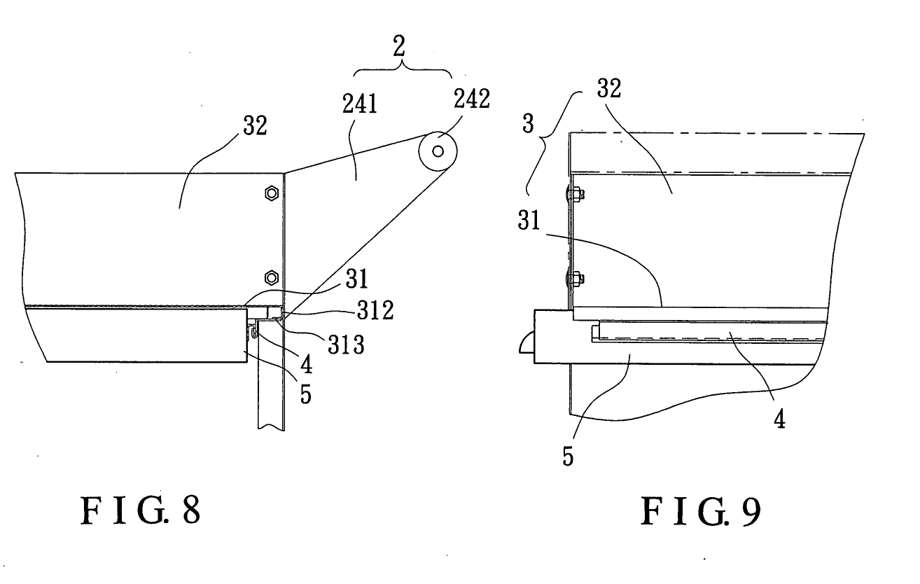

In addition, referring to FIGS. 8 and 9, guide rails 4 are secured to horizontal sections 313 of lateral edges of selected holding units 3, and drawers 5 are supported on the guide rails 4 such that the present cart has an additional use.

A method for assembling the present user-assembled multi deck cart includes the followings steps:
1. inserting the insertion portions 111 of the horizontal plate 11 into the hooking portions 121 of the lower edges of the wall portions 12 so that the wall portions 12 are held in vertical position next to front and rear edges of the horizontal plate 11;
2. inserting the lower ends 21 of the lateral plates 2 into a respective concave portion 112 of the horizontal plate 11, and joining the lateral plates 2 to the wall portions 12 by means of threaded fixing elements 23, which are passed through the through holes 221 of the lateral plates 2 and the through holes 122 of the wall portions 12, and screwed into nuts;
3. joining the holding units 3 to the lateral plates 2 in sequence, wherein one of the wall portions 32 of a first one of the holding units 3 is secured to the connecting portions 22 of the lateral plates 2 by means of threaded fixing elements 23, which are passed through the through holes 221 and 322, and screwed into nuts, and then one horizontal plate 31 is supported the above wall portion 32 by means of fitting the insertion portion 311 in the hooking portion 321 while another wall portion 32 is secured to the lateral plate 2 with the hooking portion 321 fitting with the corresponding insertion portion 311; the last action is repeated until all holding units 3 are joined to the lateral plates 2;
4. joining the supports 241 of the handle 24 to a respective one of the connecting portions 22 of one of the lateral plates 2, and joining the main body 242 to the supports 241 at two ends thereof; and
5. joining the wheels 13 to the lower side of the horizontal plate 11.

From the above description, it can be easily understood that the user-assembled multi deck cart of the present invention has advantages as followings:
1. All of the plates 2, 11, 31 and the wall portions 12, 32 can be easily fitted in position because of their shape, allowing regular users to assemble the cart by themselves quickly and easily. And, because the lateral sides of the cart are equipped with the lateral plates 2, more objects can be held on the cart. In other words, the capacity of the cart is increased.
2. The plates 11, 31, 2, the handle 24, and the wall portions 12, 32 are all separate after the cart is dismantled therefore the above parts won't occupy much space when they are stacked up in packaging. Consequently, storage and transportation expense will reduce, and the consumer can easily take them home.
3. The cart can be further equipped with guide rails 4 and drawers 5 at desired position to have an additional use. And, the holding units 1 and 3 are very strong because the horizontal plates 11 and 31 have the lateral edges as strengthening ribs while the vertical sections 312 of the lateral edges of the horizontal plates 31 are closely pressed against the lateral plates 2 for helping the holding units 3 to be stable, and allow the horizontal plates 31 to be easily moved to intended position between the lateral plates 2 in assembly.

1. A multi deck cart, comprising
a bottom holding unit including a horizontal plate, and front and rear wall portions made of narrow plates and respectively detachably connected with front and rear edges of the horizontal plate at lower edges; the horizontal plate being formed with concave portions at lateral edges thereof;
a plurality of wheels detachably joined to a lower side of the horizontal plate;
two lateral plates respectively inserted in the concave portions of the horizontal plate at lower ends; each lateral plate being folded such that front and rear edges thereof have connecting portions projecting from it; the lateral plates being detachably joined to the wall portions at the connecting portions thereof; and
a plurality of upper holding units spaced apart between the lateral plates; each holding unit including a horizontal plate, and front and rear wall portions made of narrow plates and respectively detachably connected with front and rear edges of the horizontal plate at lower edges; the holding units being detachably joined to the connecting portions of the lateral plates at the wall portions thereof.

2. The multi deck cart as claimed in claim 1, wherein the lateral plates and the holding units are made of metal materials.

3. The multi deck cart as claimed in claim 1, wherein the horizontal plate of the bottom holding unit has insertion portions at the front and the rear edges while each of the wall portions of the bottom holding unit has a hooking portion at the lower edge for allowing insertion of a corresponding insertion portion therein.

4. The multi deck cart as claimed in claim 1, wherein each of the horizontal plates of the upper holding units has insertion portions at the front and the rear edges while each of the wall portions of the upper holding units has a hooking portion at the lower edge for allowing insertion of a corresponding insertion portion therein.

5. The multi deck cart as claimed in claim 1, wherein the connecting portions of the lateral plates have through holes spaced along them, while the wall portions have through holes on two ends, and are secured to the lateral plates by means of threaded fixing elements, which are passed through the through holes thereof and the through holes of the lateral plates.

6. The multi deck cart as claimed in claim 1, wherein a handle is provided, which opposes an outer side of a first one of the lateral plates, and is secured to the first lateral plate.

7. The multi deck cart as claimed in claim 6, wherein the handle includes two supports secured to the first lateral plate, and a main body connected with the supports at two ends.

8. The multi deck cart as claimed in claim 1, wherein each of the horizontal plates of the upper holding units is folded such that each of the lateral edges thereof has a vertical section, and a horizontal section projecting inwards from the vertical section.

9. The multi deck cart as claimed in claim 8, wherein guide rails are secured to the horizontal sections of the lateral edges of the upper holding units, and drawers are supported on the guide rails.
